(19) United States
(12) Patent Application Publication
(10) Pub. No.: US 2013/0016245 A1
(43) Pub. Date: Jan. 17, 2013

(54) IMAGING APPARATUS

(71) Applicant: Motohiro Yuba, Ibaraki-shi (JP)

(72) Inventor: Motohiro Yuba, Ibaraki-shi (JP)

(73) Assignee: SANYO ELECTRIC CO., LTD., Osaka (JP)

(21) Appl. No.: 13/548,874

(22) Filed: Jul. 13, 2012

(30) Foreign Application Priority Data
Jul. 14, 2011 (JP) 2011-156012

(51) Int. Cl. H04N 5/232; H04N 5/225

(52) U.S. Cl. 348/222.1; 348/E05.024; 348/E05.045

(57) ABSTRACT

An imaging apparatus includes an imager which acquires an image signal of a subject. A first filter processer performs a filer process on a luminance signal included in the image signal in a focus area. A second filter processor performs a filter process on the luminance signal included in the image signal in the focus area and to which a cutoff frequency different from the cutoff frequency of the first filter processor is set. A first determiner determines whether or not a point light source is included in the subject. A calculator calculates an evaluation value from the luminance signal included in the image signal in the focus area. A focuser performs focus control based on the evaluation value. When it is determined that the point light source is included in the subject, the calculator calculates the evaluation value based on outputs of the first and second filter processor.

### CROSS REFERENCE OF RELATED APPLICATION

The disclosure of Japanese Patent Application No. 2011-156012, which was filed on Jul. 14, 2011, is incorporated herein by reference.

### BACKGROUND OF THE INVENTION

1. Field of the Invention

The present invention relates to an imaging apparatus, and more specifically, the present invention relates to an imaging apparatus which adjusts a focus position of an optical lens by an AF (Automatic Focus) process.

2. Description of the Related Art

One of the methods for AF control includes hill-climbing AF control (also referred to as contrast AF control). In the hill-climbing AF control, a luminance signal (Y signal) included in an image signal passes through an HPF (High-Pass Filter) thereby to detect a high-range frequency component of the luminance signal so that an integrated value (hereinafter, described as AF evaluation value) of the high-range frequency component of the luminance signal is calculated.

A focus lens position at which the integrated value is at maximum, that is, a peak position, is searched, and control is performed so that a focus lens is located at this position.

The AF evaluation value is not acquired over the entire image of a photograph region captured by an imaging apparatus, but, for example, a focus area is set to a region at a center portion of the image and the AF evaluation value is acquired for the image signal of this focus area.

Specifically, the focus area is divided into a plurality of small regions, and a high-range frequency component of a luminance signal included in an image signal is acquired for each small region.

Then, the high-range frequency component of the luminance signal acquired in each small region is integrated thereby to calculate the AF evaluation value, and control of the focus lens position is performed so that the AF evaluation value is at maximum.

It is noted that the focus lens position at which the AF evaluation value is at maximum is a position at which a subject is focused, which is also referred to as a focal point or a focal position.

A cutoff frequency (in other words, a frequency at which a limit lies) of the HPF that transmits the high-range frequency component of the luminance signal is switched depending on each subject. For example, when the subject is a low contract, the cutoff frequency of the HPF is set low (for example, to 300 KHz).

This is to avoid a situation where when the cutoff frequency of the HPF is too high, most of the frequency components of the luminance signal are blocked by the HPF, and as a result, it is difficult to detect the focal point from the AF evaluation value.

On the other hand, when the subject includes a point light source that radiates radially light from a single point such as a flare of a candle and an electric light, the subject is a high contrast, and therefore, the cutoff frequency of the HPF is set high (for example, to 2 MHz).

This is to avoid a situation where if the cutoff frequency of the HPF is too low, most of the frequency components of the luminance signal pass through the HPF, which results in a mistaken detection of the peak position of the AF evaluation value.

According to one example of this type of autofocus apparatus, it is determined whether or not a high luminance region or a low luminance region is included in a focus area based on a luminance signal of photographed image data, and when it is determined that both the high luminance region and the low luminance region are included in the focus area, a subject including a point light source is determined and the cutoff frequency of the HPF is set high, and when it is determined that there is neither high luminance region nor the low luminance region in the focus area, a subject of a low contrast is determined, and the cutoff frequency of the HPF is set low.

However, in the above-described apparatus, when it is determined that the point light source is included in the subject, the cutoff frequency of the HPF is set high irrespective of the subject other than the point light source. If the cutoff frequency of the HPF is set high, an amount of the high-range frequency component of the luminance signal outputted from the HPF is decreased.

Thus, when the subject of a low contrast, together with the subject including the point light source, is included in the focus area, it is not possible to obtain a sufficient high-range frequency component of the luminance signal from the image signal in a region in which the subject of a low contrast is included, and as a result, an absolute amount of the AF evaluation value is small, resulting in a probability of not being able to focus on the subject.

### SUMMARY OF THE INVENTION

An imaging apparatus according to the present invention comprises: an imager which acquires an image signal of a subject by imaging; a setter which sets a focus area to the image signal; a first filter processer which performs a filer process on a luminance signal included in the image signal in the focus area; a second filter processor which performs a filter process on the luminance signal included in the image signal in the focus area and to which a cutoff frequency different from the cutoff frequency of the first filter processor is set; a first determiner which determines whether or not a point light source is included in the subject a calculator which calculates an evaluation value from the luminance signal included in the image signal in the focus area; and a focuser which performs focus control based on the evaluation value, wherein when it is determined by the first determiner that the point light source is included in the subject, the calculator calculates the evaluation value based on output of the first filter processor and output of the second filter processor.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a configuration of one embodiment of an imaging apparatus 1 according to the present invention;

FIG. 2 is a flowchart showing a process operation of the imaging apparatus 1 during a normal photograph mode;

FIG. 3 is a block diagram showing an overview of an internal configuration of an AF evaluating portion 28;

FIG. 4 is an illustrative view showing overviews of an image signal P, a focus area FA, and small regions 1 to 16;

FIG. 5 is a diagram showing one example of cutoff frequencies of a high HPF 281 and a low HPF 282 during a normal time and a point light source subject time;

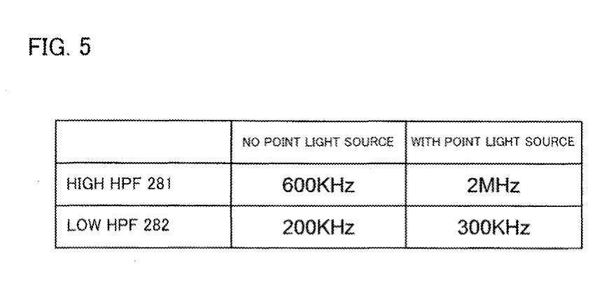

FIG. 6 is a flowchart showing an integrating process operation of an AF evaluation value when a point light source is included in a focus area FA; and

FIG. 7 is another flowchart showing the integrating process operation of the AF evaluation value when the point light source is included in the focus area FA.

### DETAILED DESCRIPTION OF THE PREFERRED EMBODIMENTS

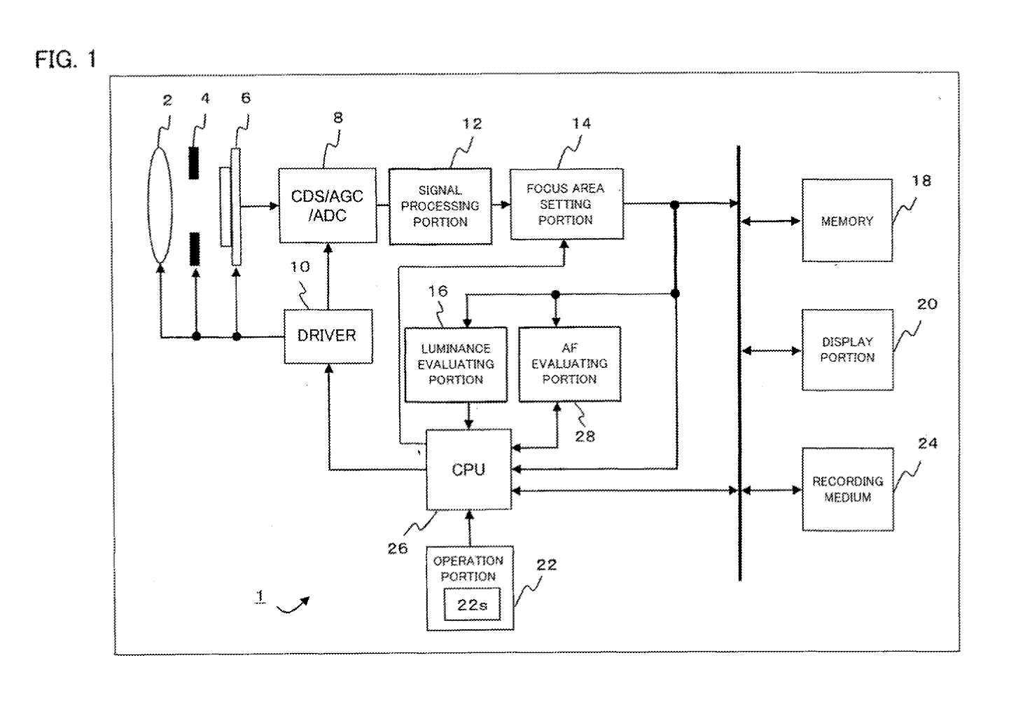

One embodiment of the present invention is described with reference to the drawings. FIG. 1 is a block diagram showing an overview of a configuration of an imaging apparatus 1 according to the present invention. The imaging apparatus 1 is provided with a focus lens 2 for focusing on a subject, an aperture 4 which adjusts an exposure amount, and an imaging element 6 which performs photoelectric conversion on an optical image of the subject to obtain an image signal, and includes a CDS/AGC/ADC 8 configured by a CDS (Correlated Double Sampling) which performs a correlated double sampling process on the image signal converted by the imaging element 6, an AGC (Automatic Gain Control) which performs automatic gain control on the same, and an ADC (Analog Digital Conversion) which performs an A/D conversion on the same. Furthermore, the imaging apparatus 1 is provided with a driver 10 which controls the focus lens 2, the aperture 4, the imaging element 6, and the CDS/AGC/ADC 8, and a signal processing portion 12 which performs processes such as a white balance adjustment, a color separation, and a YUV conversion on the image signal processed by the CDS/AGC/ADC 8.

The imaging apparatus 1 is further provided with a focus area setting portion 14 which sets a focus area including a plurality of small regions at a substantial center portion, for example, in an entire image region of the image signal processed by the signal processing portion 12, an AF evaluating portion 28 which extracts a high-range frequency component of a luminance signal from the image signal of each small region in the focus area set by the focus area setting portion 14, calculates an AF evaluation value in the focus area by integrating these components, and outputs the value to a CPU 26 described later, and a luminance evaluating portion 16 which extracts the luminance signal provided in each pixel of the image in the focus area and outputs the signal to the CPU 26 described later. The imaging apparatus 1 is further provided with a memory 18 in which the image signal is temporarily recorded in a frame unit, a display portion 20 which displays the image signal temporarily recorded in the memory 18 or an image file recorded on a recording medium 24 described later, an operation portion 22 including a shutter button 22s, the recording medium 24 in which the image signal temporarily recorded in the memory 18 is recorded in response to an operation of the shutter button 22s, and the CPU 26 which controls the entire imaging apparatus 1.

The imaging element 6 uses, for example, a solid imaging element such as a CCD (Charge Coupled Device) image sensor, or a CMOS (Complementary Metal Oxide Semiconductor) image sensor.

The memory 18 uses, for example, a VRAM (Video Random Access Memory), an SRAM (Static Random Access Memory), a DRAM (Dynamic Random Access Memory), or a generally used memory such as an SDRAM (Synchronous DRAM).

The display portion 20 uses, for example, an LCD (Liquid Crystal Display) monitor or an organic EL (Electro-Luminescence) monitor. Furthermore, the display portion 20 may be of touch-panel system which senses a contact of a finger of a human.

The recording medium 24 uses, for example, an internal recording medium, such as a flash memory or an internal HDD (Hard Disk Drive), contained in the imaging apparatus 1, or an external recording medium detachable to and from the imaging apparatus 1, such as an SD memory card, a memory stick (registered trademark), or an external HDD.

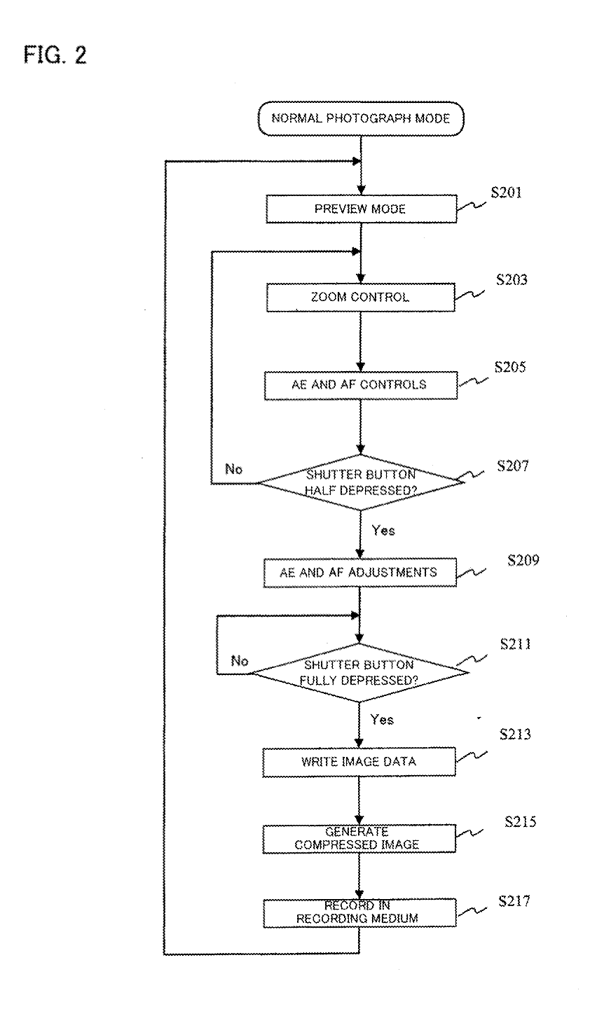

Subsequently, with reference to FIG. 2, a basic operation at the time of a still image photograph of this imaging apparatus 1 is described using a flowchart. When a power source of the imaging apparatus 1 is turned on by a user, a drive mode of the imaging apparatus 1, that is, a drive mode of the imaging element 6, is set to a preview mode (S201).

The preview mode is a mode for displaying, without recording, an image that is to be photographed on the display portion 20, and can be used for defining the subject that is to be photographed and determining a composition.

Subsequently, the mode is changed to a state to wait for a photograph mode to be inputted; modes according to a function of the imaging apparatus I or a photograph scene, such as a mode suitable for photographing a human, a mode suitable for photographing a moving object, and a mode suitable for photographing against the sun, are selected. If the photograph mode is not inputted, it is regarded that the normal photograph mode is selected.

In a preview mode, the analog image signal obtained by the photoelectric conversion operation of the imaging element 6 is converted in the CDS/AGC/ADC 8 to a digital image signal, subjected to image processes, such as a color separation, a white balance adjustment, and a YUV conversion, in the signal processing portion 12, and is written into the memory 18. The image signal written into the memory 18 is sequentially displayed on the display portion 20. As a result, a real-time moving image (preview image) representing a photograph region is sequentially displayed on the display portion 20 for each predetermined period (for example, each 1/30 seconds or each 1/60 seconds). Subsequently, the user sets a zoom magnification of the optical zoom so that a desired field angle is achieved relative to the subject that is to be photographed (S203). At this time, the CPU 26 drives the driver 10 based on the image signal inputted to the signal processing portion 12, the aperture 4 and the focus lens 2 are each controlled, and as a result, the optimal exposure control (Automatic Exposure; AE) and focus control (Automatic Focus; AF) are performed (S205). The focus control is performed in hill-climbing AF control. in the hill-climbing AF control, the high-range frequency component of the luminance signal included in the image signal of the subject image received in the imaging element 6 is detected, and the high-range frequency component of this luminance signal is integrated so as to calculate the AF evaluation value. Then, control is so performed that a focus lens position at which the AF evaluation value is at maximum, that is, a peak position, is searched, and the focus lens 2 is arranged at this position. As described above, normally, the AF evaluation value is not acquired over the entire image signal in the photograph region captured by the imaging apparatus 1; a focus area is set to within the image signal and the AF evaluation value is often acquired within the focus area. Details of the hill-climbing AF control will be described later.

When the user determines a photograph field angle and a composition, and then, half depresses the shutter button 22s of the operation portion 22 (S207, Yes), the AE adjusting process and the AF optimizing process are performed (S209).

Thereafter, when the shutter button is fully depressed (S211, Yes), a timing control signal is applied by a TG (Timing Generator: not shown) to each of the imaging element 6, the CDS/AGC/ADC 8, and the signal processing portion 12.

When the timing control signal is applied, the CPU 26 synchronizes an operation timing of each portion, sets the drive mode of the imaging element 6 to a still image photograph mode, converts the analog image signal outputted from the imaging element 6 to a digital image signal by the CDS/AGC/ADC 8, and writes it in a frame memory (not shown) within the signal processing portion 12 (S213). The digital image signal is read out from this frame memory, and is subjected to various types of signal processes, such as a signal converting process for generating a luminance signal and a color difference signal, in the signal processing portion 12.

The digital image signal on which the signal process is performed is compressed to a JPEG (Joint Photographic Experts Group) format in an image codec portion (not shown) (S215), and thereafter, a compressed image is written onto the recording medium (S217). This completes the photograph. Then, the process returns to the preview mode.

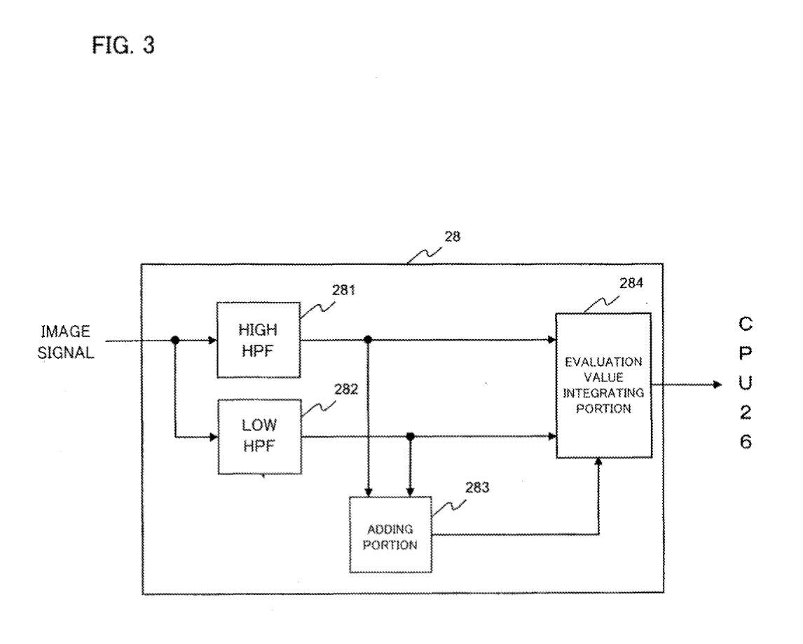

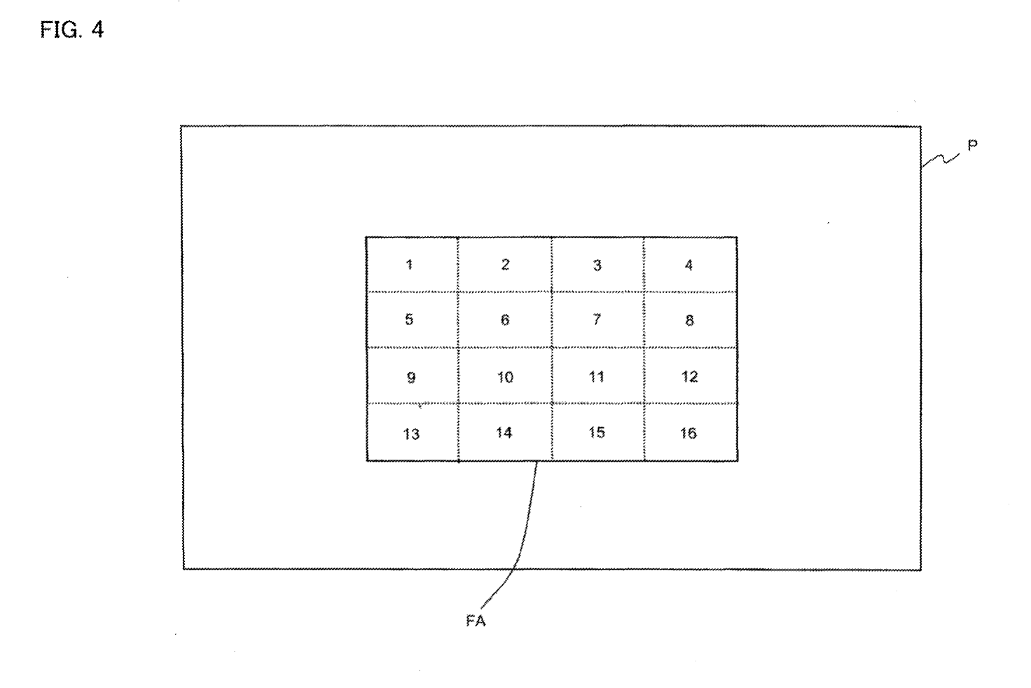

Subsequently, the hill-climbing control is described The hill-climbing AF control is realized as follows, for example. FIG. 3 is a block diagram showing an overview of an internal configuration of the AF evaluating portion 28. FIG. 4 shows an image Pin a photograph region acquired by the imaging apparatus 1, a focus area FA, and small regions 1 to 16 generated by dividing the focus area FA.

The AF evaluating portion 28 is provided with a high HPF 281 and a low HPF 282 in which a cutoff frequency is set lower than that of the high HPF 281.

Furthermore, the AF evaluating portion 28 is provided with an adding portion 283 which adds a high-range frequency component of the luminance signal outputted from the high HPF 281 and a high-range frequency component of the luminance signal outputted from the low HPF 282, and an evaluation value integrating portion 284 which integrates the high-range frequency components of the luminance signals outputted from the high HPF 281, the low HPF 282, and the adding portion 283 so as to calculate the AF evaluation value.

The image P to which the focus area FA is set by the focus area setting portion 14 is outputted to each of the luminance evaluating portion 16 and the AF evaluating portion 28.

In the AF evaluating portion 28, the luminance signal included in the image signals of the focus area FA, out of the image signals forming the image P, is inputted to each of the high HPF 281 and the low HPF 282.

Thereby, the high-range frequency components of the luminance signal are respectively outputted from the HPFs, and as a result of the high-range frequency components being integrated, the AF evaluation value is calculated.

It is noted that the image signal within the focus area FA is inputted to each of the high HPF 281 and the low HPF 282; however, when the point light source is not included in the subject, the evaluation value integrating portion 284 integrates only the high-range frequency component of the luminance signal outputted from the high HPF 281 thereby to calculate the AF evaluation value.

Moreover, the high HPF 281 and the low HPF 282 are capable of switching the cutoff frequencies depending on each subject.

The cutoff frequency of each HPF and the subject are corresponded so that when the point light source is not included in the subject, the cutoff frequency of the high HPF 281 is set to 600 KHz and the cutoff frequency of the low HPF 282 is set to 200 KHz, for example, as shown in FIG. 4.

On the other hand, when the point light source is included in the subject, the cutoff frequency of the high HPF 281 is set to 2 MHz and the cutoff frequency of the low HPF 282 is set to 300 KHz. It is noted that the cutoff frequencies shown in FIG. 4 are one example, and are not limited thereto.

The focus area setting portion 14 sets the focus area FA to a center portion of the image P, and further divides the focus area FA so as to generate 16 small regions 1 to 16.

It is noted that in this embodiment, the description is provided when the number of small regions is 16; however, the number of small regions is not limited thereto, and a further division may be possible. Furthermore, the position at which the focus area FA is set is not always at the center portion of the image.

When the focus area FA is set, the focus area setting portion 14 outputs the luminance signal included in the image signal corresponding to the focus area FA, to the luminance evaluating portion 16.

Subsequently, the CPU 26 determines whether or not the point light source is included within the focus area FA. A method of determining whether or not the point light source is included will be described later.

When it is determined that the point light source is included within the focus area FA, the cutoff frequencies of the high HPF 281 and the low HPF 282 are switched to a cutoff frequency for a point light source.

Subsequently, the AF evaluating portion 28 makes a determination to each of the small regions 1 to 16 configuring the focus area FA to know whether or not these small regions are influenced by the point light source.

As a result, when the small region is determined to be influenced by the point light source, only the high-range frequency component outputted from the high HPF 281, regarding the luminance signal of the image signal corresponding to the small region, is outputted to the evaluation value integrating portion 284.

On the other hand, when the small region is determined not to be influenced by the point light source, the high-range frequency component outputted from the high HPF 281 and the high-range frequency component outputted from the low HPF 282, regarding the luminance signal included in the image signal corresponding to the small region, are outputted to the adding portion 283.

The adding portion 283 adds the high-range frequency component outputted from the high HPF 281 and the high-range frequency component outputted from the low HPF 282, and outputs the same to the evaluation value integrating portion 284.

This is to avoid a risk that when the small region not affected by the point light source is low contrast, a sufficient AF evaluation value cannot be acquired only by the high-range frequency component outputted from the high HPF 281.

When the point light source is included within the focus area FA, the evaluation value integrating portion 284 integrates the high-range frequency component outputted from the high HPF 281 and the high-range frequency component outputted from the adding portion 283 so as to calculate the AF evaluation value.

In this way, one frame of the integrated value of the high-range frequency component of the image signal included within the focus area FA is acquired as the AF evaluation value, and is outputted to the CPU 26.

The CPU 26 controls the position of the focus lens 2 via the driver 10 so that the AF evaluation value from the AF evaluating portion 28 is at maximum (at peak).

As a result, even when the subject of a low contrast is mixed at the same time when there is the subject including the point light source, the imaging apparatus 1 is capable of integrating a sufficiently absolute amount of the AF evaluation values, which allows for an appropriate focus on the subject.

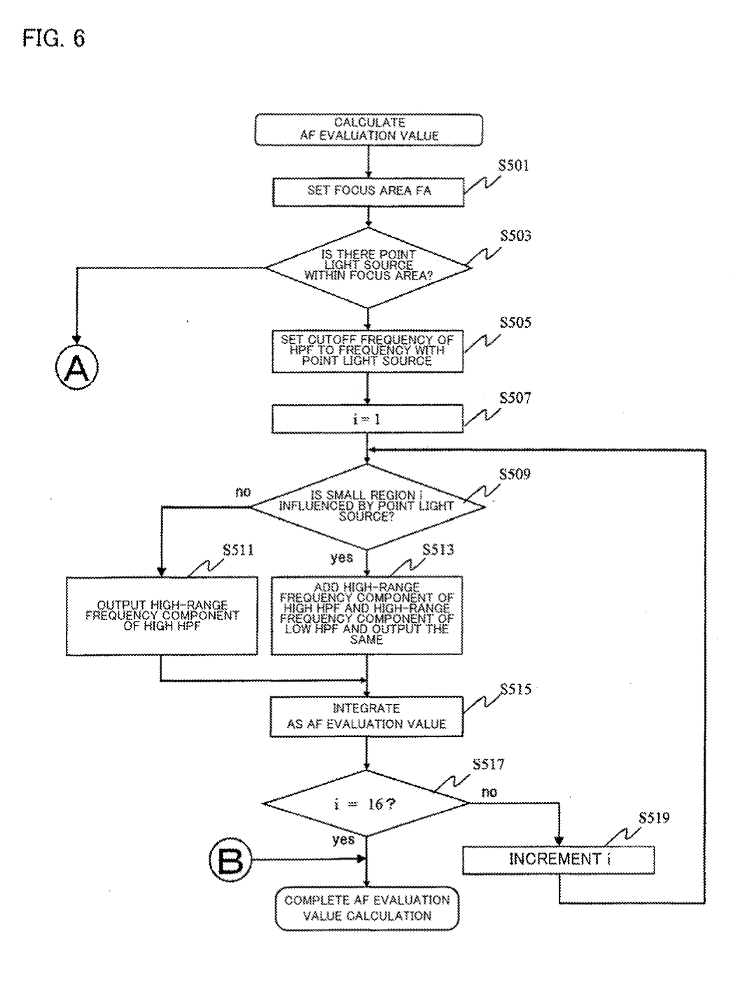

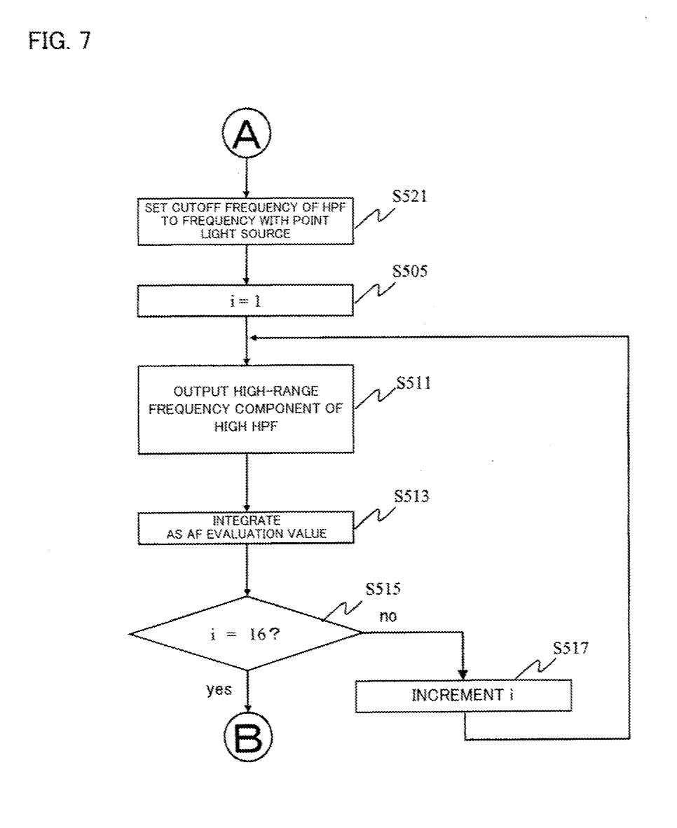

FIG. 6 and FIG. 7 are flowcharts showing the processing operation of the hill-climbing AF control when the point light source is included within the focus area FA. It is noted that the same processing operation is performed in a portion to which the same reference numeral is assigned in FIG. 6 and FIG. 7.

In a step S501, the focus area FA is set to the image P, and the process proceeds to a step S503. In the step S503, it is determined whether or not the point light source is included within the focus area FA.

When the point light source is included within the focus area FA, the process proceeds to a step S505, and otherwise, the process proceeds to a step S521.

In the step S505, the cutoff frequencies of the high HPF 281 and the low HPF 282 are set to the frequency obtained when the point light source is included, and the process proceeds to a step S507. In the step S507, i=1 is set, and the process proceeds to a step S509. In the step S509, it is determined whether or not a small region i is influenced by the point light source. In a case of being influenced by the point light source, the process proceeds to a step S513, and otherwise, the process proceeds to a step S511.

In the step S511, the high-range frequency component of the luminance signal outputted from the high HPF 281 to which the cutoff frequency obtained when the point light some is included in the subject is set is outputted to the evaluation value integrating portion 284.

In a step S513, the high-range frequency components obtained by adding the high-range frequency component of the luminance signal outputted from the high HPF 281 and the high-range frequency component of the luminance signal outputted from the low HPF 282 by the adding portion 283 is outputted to the evaluation value integrating portion 284.

In a step S515, the outputted high-range frequency component is integrated as the AF evaluation value, and the process proceeds to a step S517. In the step S517, it is determined whether or not i=16 is set. When i=16 is set, the integration of the AF evaluation value is ended, and otherwise, the process proceeds to a step S519.

In the step S519, a value of i is incremented. After the value of i is incremented, the process returns to the step S503.

In a step S521, the cutoff frequencies of the high HPF 281 and the low HPF 282 are set to the frequency obtained when there is no point light source, and the process proceeds to a step S507.

In a step S523, the high-range frequency component of the luminance signal outputted from the high HPF 281 to which the cutoff frequency obtained when there is no point light source in the subject is set is outputted to the evaluation value integrating portion 284. In a step S525, i is incremented, and the process returns to the step S523.

Subsequently, a point light source determining process for determining whether or not the point light source is included within the focus area FA is described.

The focus area setting portion 14 outputs, when the focus area FA is set, the image signal included within the focus area FA to the luminance evaluating portion 16.

The luminance evaluating portion 16 detects the luminance signal of each pixel of the image signal outputted from the focus area setting portion 14, and outputs the detection result to the CPU 26.

The CPU 26 acquires the luminance signal (Y signal) of each pixel included within the focus area FA set to the image signal P, from the detection result outputted from the luminance evaluating portion 16. Subsequently, the CPU 26 determines whether or not the high luminance region is included within the focus area FA, based on the acquired luminance signal of each pixel.

Specifically, based on the luminance signal of each pixel included within the focus area FA, the number of pixels that are higher in luminance than a first threshold value is counted, and it is determined whether or not a ratio of the number of pixels that are higher in luminance than the first threshold value relative to a total number of pixels of the image signal included within the focus area FA is greater than a first ratio (for example, 0.2%).

The CPU 26 determines that the high luminance region is included when the ratio of the number of pixels that are higher in luminance than the first threshold value relative to the total number of pixels of the image signal included within the focus area FA is greater than the first ratio.

When it is determined that the high luminance region is included within the focus area FA, the CPU 26 subsequently determines whether or not the low luminance region is included within the focus area FA. Specifically, based on the luminance signal of each pixel included within the focus area FA set to within the image signal P, the number of pixels that are lower in luminance than a second threshold value is counted, and it is determined whether or not a ratio of the number of pixels that are lower in luminance than the second threshold value relative to a total number of pixels of the image signal corresponding to within the focus area FA is greater than a second ratio (for example, 2%).

The CPU 26 determines that the low luminance region is included when the ratio of the number of pixels that are lower in luminance than the second threshold value relative to the total number of pixels of the image signal included within the focus area FA is greater than the second ratio.

In this way, when it is determined that both of the high luminance region and the low luminance region are included within the focus area FA, the subject including the point light source is determined, and the CPU 26 switches the cutoff frequencies of the high HPF 281 and the low HPF 282 to the frequency for a point light source.

When the subject including the point light source is determined, the CPU 26 makes a determination to each of the small regions to know whether these small regions are each the small region including the point light source. In the determination, in each small region, the number of pixels that are higher in luminance than a third threshold value is counted, and it is determined whether or not a ratio of the number of pixels that are higher in luminance than the third threshold value relative to a total number of pixels of the image signal included in the small regions is greater than a third ratio (for example, 10%).

In the above-described embodiment, the focus area FA is set to a center portion of the image, and the set focus area FA is divided so as to generate the small regions; however, the entire image signal may be divided into a plurality of small regions, and a plurality of small regions equivalent to the center portion of the image signal P, out of the divided small regions, may be set to the focus area FA.

Furthermore, the focus area FA is set to the image that has been subjected to the signal process; however, for example, the focus area FA may be set to an image that is photoelectric converted by the imaging element or an image that is A/D converted by the CDS/AGC/ADC 8.

Moreover, the cutoff frequencies of the high HPF 281 and the low HPF 282 are switched depending on the presence or absence of the point light source, and in addition, the position, the size of the focus area FA may also be switched.

Furthermore, when determining whether or not the point light source is included in the subject, the determination is made as to whether or not the ratio in which the pixels higher in luminance than the first threshold value are included is greater than the first ratio and the ratio in which the pixels lower in luminance than the second threshold value are included is greater than the second ratio.

However, when the number of pixels of the image signal included within the focus area FA is known in advance, whether or not the point light source is included in the subject may be determined by the number of pixels that are higher in luminance than the first threshold value and the number of pixels that are lower in luminance than the second threshold value.

Although the present invention has been described and illustrated in detail, it is clearly understood that the same is by way of illustration and example only and is not to be taken by way of limitation, and the spirit and scope of the present invention being limited only by the terms of the appended claims.

What is claimed is:

1. An imaging apparatus, comprising:
an imager which acquires an image signal of a subject by imaging;
a setter which sets a focus area to the image signal;
a first filter processer which performs a filer process on a luminance signal included in the image signal in the focus area;
a second filter processor which performs a filter process on the luminance signal included in the image signal in the focus area and to which a cutoff frequency different from the cutoff frequency of said first filter processor is set;
a first determiner which determines whether or not a point light source is included in the subject;
a calculator which calculates an evaluation value from the luminance signal included in the image signal in the focus area; and
a focuser which performs focus control based on the evaluation value, wherein when it is determined by said first determiner that the point light source is included in the subject, said calculator calculates the evaluation value based on output of said first filter processor and output of said second filter processor.

2. An imaging apparatus according to claim 1, further comprising:
a focus lens; and
a driver which drives said focus lens along an optical axis direction, wherein
said calculator calculates the respective evaluation values at different focus lens positions while driving said focus lens by said driver, and
said focuser arranges said focus lens at a position at which the evaluation value is at maximum.

3. An imaging apparatus according to claim 1, wherein the focus area is formed of a plurality of small regions, and said calculator calculates the evaluation value for each of the plurality of small regions.

4. An imaging apparatus according to claim 3, further comprising a second determiner which determines, when it is determined by said first determiner that a point light source is included in the subject, whether or not each of the plurality of small regions is a small legion that is influenced by the point light source, wherein said evaluation value calculator calculates the evaluation value based on output by said first filter processor in a small region that is determined, by said second determiner, to be influenced by the point light source, and calculates the evaluation value based on the output by said first filter processor and output by said second filter processer in a small region that is determined not to be influenced by the point light source.
